(19) United States
(12) Patent Application Publication
(10) Pub. No.: US 2021/0266737 A1
(43) Pub. Date: Aug. 26, 2021

(54) MULTI-USAGE CONFIGURATION TABLE FOR PERFORMING BIOMETRIC VALIDATION OF A USER TO ACTIVATE AN INTEGRATED PROXIMITY-BASED MODULE

(71) Applicant: NextGen Monetization Trust, Newark, DE (US)

(72) Inventor: Christopher John Burke, Central (HK)

(73) Assignee: NextGen Monetization Trust, Newark, DE (US)

(21) Appl. No.: 16/797,195

(22) Filed: Feb. 21, 2020

(51) Int. Cl. H04W 12/06; G06F 16/2455; H04W 12/00; G06F 3/0482

(52) U.S. Cl. CPC H04W 12/06; G06F 3/0482; H04W 12/00503; G06F 16/24553

(57) ABSTRACT

An interactive computing device has an integrated memory device, which stores a multi-usage configuration table that identifies a plurality of real-world contexts, which are distinct from one another, a biometric template corresponding to each of the plurality of real-world contexts, and a biometric database corresponding to biometric data of a user of the interactive computing device. The biometric template identifies one or more biometric modalities based on one or more access request types. Furthermore, the interactive computing device has a proximity-based detection module, integrated within the interactive computing device, that detects proximity to a proximity-based reader positioned externally to the interactive computing device. Additionally, the interactive computing device has a proximity-based transmission module and a user input device integrated within the interactive computing device; the user input device receives a biometric input of the user.

### BACKGROUND

### 1. Field

This disclosure generally relates to the field of biometric devices. More particularly, the disclosure relates to biometric validation of a user.

### 2. General Background

With recent advances in technology, various types of devices have allowed users to obtain access to different services that necessitate some form of validation of the user. For example, rather than using a conventional credit card with a magnetic stripe on the back of it, users are now able to use proximity cards that essentially allow for a more secure, contactless form of payment without having to insert a credit card into a reader device. As another example, a user (e.g., student, employee, etc.) requiring access to a building may use a proximity card to obtain such access.

However, a disadvantage of current proximity card configurations is that multiple proximity cards would have to be carried by a user to obtain access to the variety of services provided by the proximity cards. For example, the user may have to carry a first proximity card for payment purposes at a grocery store, and a second, distinct proximity card to obtain access to a building; the reason for this is that the issuer of the first proximity card is typically a financial institution, whereas the issuer of the second proximity card is a typically a building management company. (The two foregoing examples are just two of many possible examples using proximity card configurations.)

Furthermore, the security of one form of contactless access technology may vary from one area to another. For instance, a contactless card that is used for payments may necessitate entry of a personal identification number (“PIN”), whereas a contactless card to obtain access to a building may not require a PIN or any other form of validation, rendering this particular contactless card vulnerable to being used for improper building access if stolen from the user.

Accordingly, current contactless access systems are inconsistent from a security perspective and inconvenient for end-users. Therefore, current systems do not effectively provide optimal contactless access to services.

### SUMMARY

In one aspect of the disclosure, an interactive computing device has an integrated memory device, which stores a multi-usage configuration table that identifies a plurality of real-world contexts, which are distinct from one another, a biometric template corresponding to each of the plurality of real-world contexts, and a biometric database corresponding to biometric data of a user of the interactive computing device. The biometric template identifies one or more biometric modalities based on one or more access request types. Furthermore, the interactive computing device has a proximity-based detection module, integrated within the interactive computing device, that detects proximity to a proximity-based reader positioned externally to the interactive computing device. Additionally, the interactive computing device has a proximity-based transmission module and a user input device integrated within the interactive computing device; the user input device receives a biometric input of the user. Finally, the interactive computing device has a processor that determines one of a plurality of context indicia, performs biometric validation by comparing the biometric input with the biometric data of the user stored in the biometric database, and activates, based upon the biometric validation, the proximity-based transmission module to transmit access data to the proximity-based reader to access to the context corresponding to the automated selection.

In another aspect of the disclosure, a localized context selection process is performed by the interactive computing device. The process stores, with the memory device, the multi-usage configuration table, the biometric template, and the biometric database. Furthermore, the process detects the proximity with the proximity-based detection module integrated within the interactive computing device. The process also generates, with a processor integrated within the interactive computing device, a user interface having a menu of a plurality of context indicia, each of the plurality of context indicia corresponding to one of the plurality of real-world contexts. Moreover, the process receives, via a menu selection user input at the interactive computing device, a menu selection of one of the plurality of context indicia from the menu. The process may then proceed to receive the biometric input of the user, perform the biometric validation, and activate the proximity-based transmission module to transmit access data to the proximity-based reader to access the context corresponding to the menu selection.

In another aspect of the disclosure, a context selection process is at least partially cloud-based. The process stores, with the memory device, the multi-usage configuration table, the biometric template, and the biometric database. Furthermore, the process detects the proximity with the proximity-based detection module integrated within the interactive computing device. Additionally, the process determines, with a sensor positioned within the interactive computing device, a real-world physical location of the interactive computing device. Also, the process provides the real-world physical location to a server. The process receives, from the server, an automated selection of one of a plurality of context indicia without receiving a direct input indicating the automated selection from the user. The one of the plurality of context indicia corresponds to the real-world physical location. Subsequently, the process may then proceed to receive the biometric input of the user, perform the biometric validation and activate the proximity-based transmission module to transmit access data to the proximity-based reader to access the context corresponding to the menu selection.

In yet another aspect of the disclosure, a computer program product is provided. The computer program product comprises a non-transitory computer useable storage device having a computer readable program. The computer readable program when executed on the interactive computing device causes the interactive computing device to perform the foregoing processes.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1A illustrates a user interacting with an interactive computing device that integrates biometric validation.

FIG. 1B illustrates a display screen displaying a virtual fingerprint pad to accept a fingerprint from the user prior to processing payment data transmission from the interactive computing device to the merchant's point-of-sale (“POS”) terminal.

FIG. 2A illustrates a system configuration in which the interactive computing device implements the graphical user interface (“GUI”) via a software application.

FIG. 2B illustrates a system configuration in which the interactive computing device uses an integrated sensor to allow the server to perform an automatic context selection for the user, without any menu selection by the user.

FIG. 3A illustrates a system configuration for the interactive computing device.

FIG. 3B illustrates a system configuration for the server illustrated in FIG. 2B.

FIG. 4 illustrates an example of the multi-usage configuration table stored by the data storage device of the interactive computing device illustrated in FIG. 3A.

FIG. 5A illustrates the GUI depicting the building access indicium as the selected context.

FIG. 5B illustrates the user providing an input via the biometric modality specified by the multi-usage configuration table illustrated in FIG. 4 to obtain access to a building in a controlled access building context.

FIG. 6A illustrates the GUI depicting the payments indicium as the selected context.

FIG. 6B illustrates the user providing an input via the biometric modality specified by the multi-usage configuration table illustrated in FIG. 4 to provide payment in a payment context.

FIG. 7A illustrates the GUI depicting the computer access indicium as the selected context.

FIG. 7B illustrates the user providing an input via the biometric modality specified by the multi-usage configuration table illustrated in FIG. 4 to unlock access to the personal computer (“PC”).

FIG. 8 illustrates a time-based context selection data structure, generated by the server, to automatically select a context for the user.

FIG. 9 illustrates a process that may be utilized by the interactive computing device to transmit data from the proximity-based module, illustrated in FIG. 3A, to a proximity-based reader based upon a user menu selection from contexts corresponding to the multi-usage configuration table, illustrated in FIG. 4.

FIG. 10 illustrates a process that may be utilized by the interactive computing device to transmit data from the proximity-based module, illustrated in FIG. 3A, to a proximity-based reader based upon an automated selection from contexts corresponding to the multi-usage configuration table, illustrated in FIG. 4.

### DETAILED DESCRIPTION

A multi-usage configuration table is provided for performing biometric validation of a user to activate an integrated proximity-based module. For instance, an interactive computing device (e.g., smartphone, tablet device, smartwatch, smart bracelet, tablet device, smart badge, smart necklace, etc.) may have an integrated proximity-based module (e.g., physical integrated circuit, logical integrated circuit, etc.) that performs contactless communication with a control device external to the interactive computing device to provide access to a service (e.g., payments, building control access, medical records, etc.). (The term “contactless” is intended to encompass a short distance (e.g., one to ten centimeters) from a device reader, but may permit contact, such as a tap, and may potentially be used with longer distances than ten centimeters. Examples of such contacts communication included, but are not limited to, wireless communication such as Near Field Communication (“NFC”), radio frequency identification (“RFID”), BLUETOOTH, or the like.) The multi-usage configuration table establishes which form of biometric validation of a user is necessary to activate the proximity-based module to obtain access from a particular external control device (e.g., access control panel, merchant point of sale (“POS”) terminal, etc.). For instance, the multi-usage configuration table may determine that a fingerprint validation of a user is required to send user payment information from a smartphone to a merchant POS terminal, whereas an iris validation is required to send user credentials to an access panel at a particular building. In essence, the biometric validation is used to locally validate, within the interactive computing device, the user as the user associated with credentials stored by the interactive computing device prior to transmission of user data, especially secure or sensitive data, from the interactive computing device. Accordingly, in contrast with previous configurations that necessitated multiple validation devices (e.g., multiple proximity cards), the multi-usage configuration table allows for the interactive computing device to have an integrated proximity-based device (e.g., NFC transceiver, RFID transceiver, BLUETOOTH transceiver, etc.) that is activated to transmit user data only upon the particular type of biometric validation dictated by the multi-usage configuration table. As a result, the interactive computing device is a universal device that may be used for all, or most, of the user's contactless access needs; avoiding the inconvenience of multiple devices/proximity cards.

Furthermore, the multi-usage configuration table allows for universal, enhanced security. Rather than having various forms of security that run the gamut in terms of security, depending upon the type of contactless access used by the end-user, the multi-usage configuration table allows the interactive computing device to use the same, consistent security mechanism for some, or all, of its contactless communication; what varies is just the biometric validation. In other words, the same secure form of data transmission may be used in varying contexts, even though the forms of biometric validation required to invoke such data transmissions may be vary—all from the same interactive computing device. Alternatively, the multi-usage configuration table may allow for various forms of secure transmission, but may automatically dictate such variations without the need for user intervention. For example, the interactive computing device may alter the type of encryption used for different contexts, as dictated by the multi-usage configuration table.

In one embodiment, the interactive computing device is interactive in that it interacts with the end-user to determine a particular context for biometric mechanism selection. For example, the interactive computing device may display a GUI that may allow the end-user to provide a user input indicating which context (e.g., payments, building access control, medical authorization, automobile access, etc.) is currently needed by the user. In another embodiment, the interactive computing device automatically interacts with the environment in which the user is positioned, irrespective of whether or not it receives a user input from the user while the user is positioned within that physical environment. For example, the interactive computing device may have a location-based sensor (e.g., global positioning system (“GPS”)) that determines the location of the user. The interactive computing device may then identify the physical environment (e.g., store, access-controlled building, automobile, etc.), and automatically select the corresponding biometric validation for the user's location. In one embodiment, the interactive computing device may use an Artificial Intelligence (“AI”) system to perform predictive analytics to identify the physical environment, and the potential use. For example, a user may have previously visited a controlled-access building and purchased lunch in the cafeteria of that building. As such, identifying the location does not suffice for biometric validation selection, but the AI may determine with a high probability that a typical sequence of events is building access selection prior to payment selection. As another example, the interactive computing device may be configured to receive identification data from transmitters emitting such identification data. In yet another embodiment, the interactive computing device allows for interaction from both the user and the surrounding physical environment.

As an example, a software application may be used by the interactive computing device to generate the GUI. The software application may be cloud-based for the purpose of generating the GUI and identifying/performing biometric validation selections, but the biometric validation itself would be performed locally on the interactive computing device, thereby enhancing the security of the biometric validation. In an alternative embodiment, some or all of the biometric validation may be performed by a remotely-situated server. In essence, the software application generates the GUI to improve the user experience of the user. Rather than having to carry potentially dozens of different proximity cards and figure out which one has to be used in which physical location, the GUI allows the user to easily select the context (e.g., payments, controlled access to a building, etc.) and perform the corresponding biometric validation via the interactive computing device itself (e.g., integrated camera, fingerprint scanner, etc.) or an accessory device (e.g., accessory camera, fingerprint scanner, etc.) in operable communication (wired or wireless) with the interactive computing device.

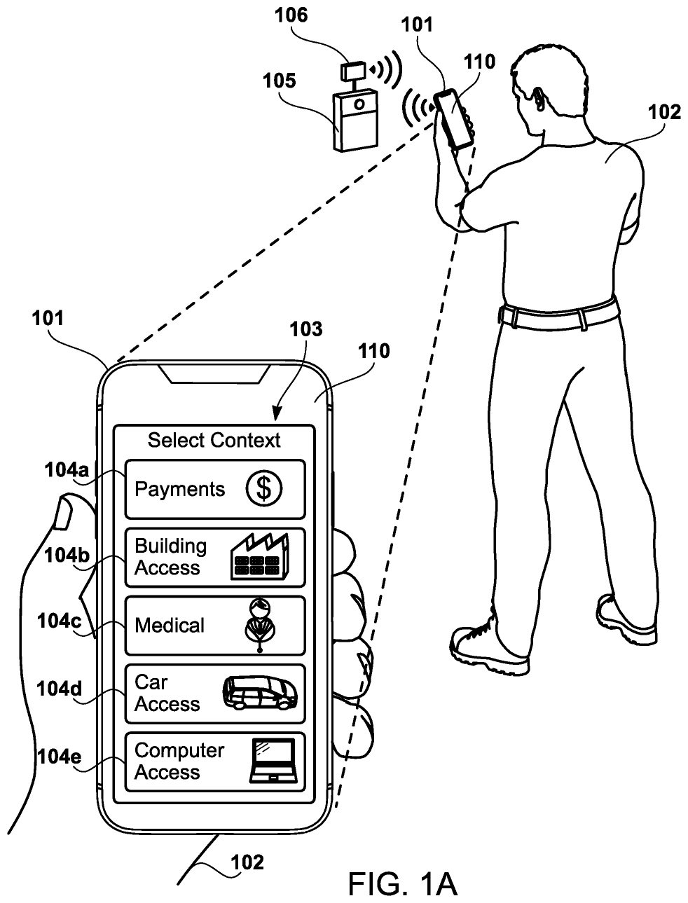

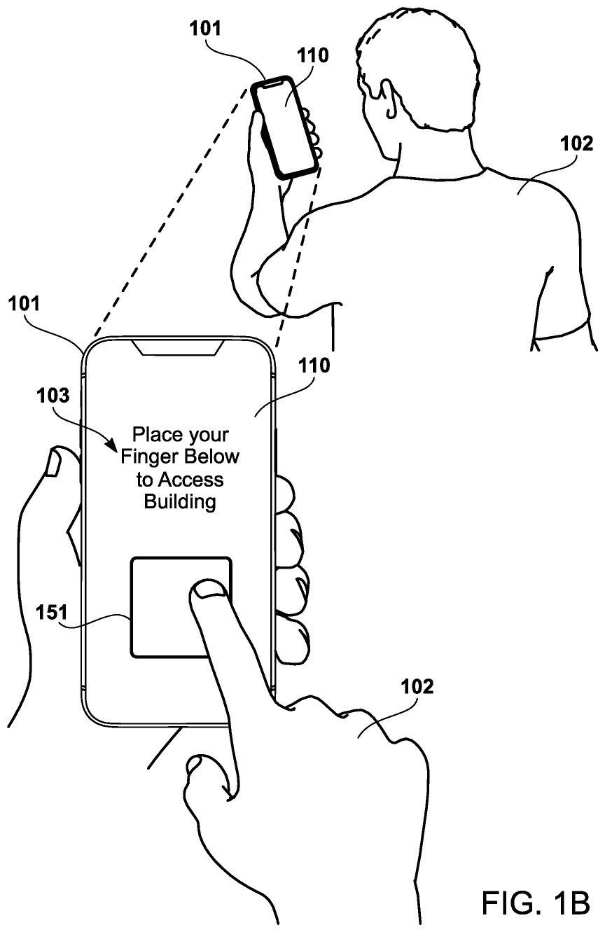

FIGS. 1A and 1B illustrate use of an interactive computing device 101. In particular, FIG. 1A illustrates a user 102 interacting with an interactive computing device 101 that integrates biometric validation within the interactive computing device 101 itself. Upon being positioned within proximity to a proximity-based reader 105, which is distinct from the interactive computing device 101, the user 102 interacts with a GUI 103 displayed by a display screen 110 of the interactive computing device 101. The GUI 103 illustrates a variety of different example context menu indicia (e.g., menu selections), such as a payment selection indicium 104a, a building access indicium 104b, a medical records indicium 104c, an automobile access indicium 104d, and a computer access indicium 104e. (The menu indicia illustrated in FIG. 1A are provided only as examples. Other types of context menu indicia may be used instead.) Optionally, in some contexts (e.g., medical record data transfer to the interactive computing device 101), the proximity-based reader 105 may be in operable communication, or integrated, with a proximity-based transmitter 106 to transmit data to the interactive computing device 101 after biometric validation; in other contexts (e.g., building access), the proximity-based reader 105 suffices because data does not necessarily have to be transferred back to the interactive computing device 101. In such instances, the proximity-based reader 105 may communicate, locally or remotely, with an access controller to provide access (e.g., door activation for entry) to the user 102.

In essence, the user 102 may use one device, the interactive computing device 101, to select the context in which the user wants to obtain a particular service. (The term “service” is used herein to refer to a variety of feature offerings including, but not limited to, building access control, payment processing, downloading of data, activating hardware or machinery, unlocking hardware or machinery, identification, or the like.) By identifying such context, the user 102 enables the interactive computing device 101 to determine a corresponding form of biometric validation for that context (different contexts may have different forms of biometric validation) and present the corresponding biometric input request to the user 102. For example, if the user 102 is at a merchant location, he or she may select the payments indicium 104a to process a payment via the interactive computing device 101. As such, the interactive computing device 101 may select which form of biometric validation should be used prior to allowing the payment information to be wirelessly transmitted from the interactive computing device 101 to a proximity-based device reader 105 located at the merchant's POS terminal. For example, as illustrated in FIG. 1B, the display screen 110 may display a virtual fingerprint pad 151 to accept a fingerprint from the user 102 prior to processing payment data transmission from the interactive computing device 101 to the merchant's POS terminal.

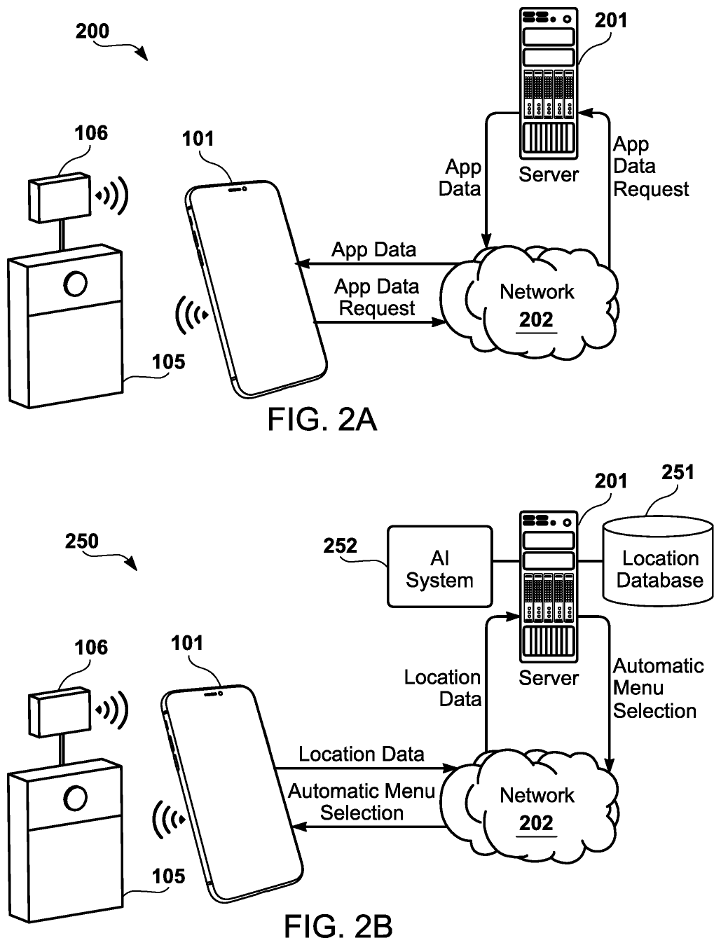

FIGS. 2A and 2B illustrate various system configurations in which the interactive computing device 101 may be implemented. In particular, FIG. 2A illustrates a system configuration 200 in which the interactive computing device 101 implements the GUI 103 via a software application. The interactive computing device 101 sends a request, through a network 202, to a server 201 to obtain the software application data, and the server 201 responds with the requested software application data, thereby allowing the interactive computing device 101 to generate and render the software application, including the GUI 103, on the display device 110. Subsequently, upon performing biometric validation for the biometric modality corresponding to the menu selection, the interactive computing device 101 may transmit access data to the proximity-based reader 105, and receive access data from the proximity-based transmitter 106. In essence, the interactive computing device 101 in the system configuration 200, illustrated in FIG. 2A, relies on interaction with the user 102.

Alternatively, FIG. 2B illustrates a system configuration 250 in which the interactive computing device 101 uses an integrated sensor to allow the server 201 to perform an automatic context selection for the user 102, without any menu selection by the user. In particular, the interactive computing device 101 may use a sensor (e.g., Global Positioning System (“GPS”)) to determine the location of itself, and send that location data, through the network 202, to the server 201. Furthermore, the server 201 may search through a location database 251, which it is in operable communication with, to determine a corresponding context. For instance, the server 201 may determine that a merchant is present at the location corresponding to the location sensed by the sensor of the interactive computing device 101. Accordingly, the server 201 may automatically select the payments indicium 104a, without necessitating a direct menu selection from the user 102. As a result, the user 102 may approach a payment terminal at the merchant, and have the corresponding biometric input modality (e.g., thumbprint for payments) appear without any direct user menu selection. Optionally, an AI system 252 may be utilized by the server 201 to perform predictive analytics, based upon previous statistical samples of the user's behavior and/or other users' behaviors, to select different contexts at the same location (e.g., payments or medical records). The user 102 may provide a user input to override any context selections automatically performed by the server 201. In essence, the interactive computing device 101 in the system configuration 250, illustrated in FIG. 2B, relies on interaction with the physical environment, rather than the user 102.

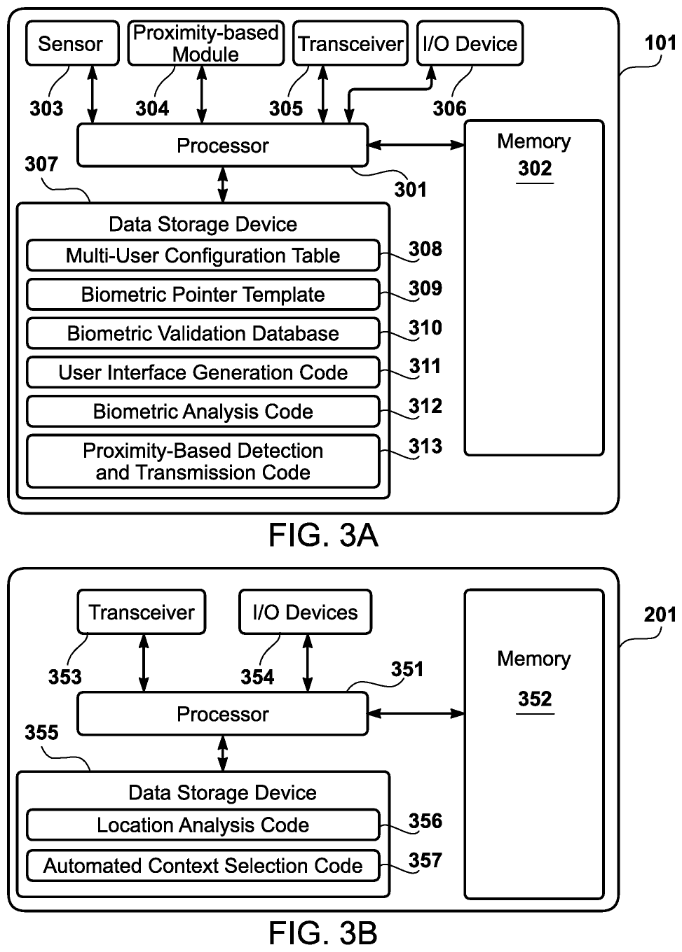

FIGS. 3A and 3B illustrate system configurations for the various componentry of the interactive computing device 101 and the server 201, respectively. In particular, FIG. 3A illustrates a system configuration for the interactive computing device 101. A processor 301 may be specialized for data structure generation, biometric operations, and GUI generation.

The system configuration may also include a memory device 302, which may temporarily store data structures used by the processor 301. As examples of such data structures, a data storage device 307 within the system configuration may store a multi-usage configuration table 308, a biometric pointer template 309, and a biometric validation database 310. The processor 301 may use the multi-usage configuration table 308 to configure a proximity-based module 304, integrated within the interactive computing device 101. For instance, the multi-usage configuration table 308 may indicate a particular biometric pointer template 309, which is pointed to with respect to a particular context. The biometric pointer template 309 may then indicate a particular modality (e.g., fingerprint, thumbprint, iris scan, facial recognition, etc.) has to be received from the user 102 for biometric validation for the corresponding context. Upon receiving the corresponding biometric input, the processor 301 may search the biometric validation database 310, which is only locally stored within the interactive computing device 101 for security purposes, to determine whether or not the biometric data inputted by the user 102 matches the biometric data stored in the biometric database 310, thereby performing biometric validation of the user 102.

Furthermore, the memory device 302 may temporarily store computer readable instructions performed by the processor 301. For instance, the memory device 302 may temporarily store user interface generation code 311, which the processor 301 may execute to generate the GUI 103. Additionally, the memory device 302 may temporarily store biometric analysis code 312, which the processor 301 may execute to perform biometric validation. Finally, the memory device 302 may temporarily store the proximity-based detection and transmission code 313 to allow the processor 301 to use the proximity-based module 304 to detect the presence of the proximity-based reader 105 and transmit access data, upon biometric validation, to the proximity-based reader 105.

In one embodiment, the proximity-based module 304 is a physical circuit, such as an NFC physical circuit. Upon detecting the presence of an NFC-based reader 105, the NFC-based module 304 awaits an indication of biometric validation from the processor 301, at which time the NFC-based circuit transitions from an open position to a closed position to transmit access data, via magnetic inductive communication, to the NFC-based reader 105. In another embodiment, the proximity-based module 304 is a logical circuit that is implemented via software. Furthermore, the proximity-based module 304 may perform its functionality via two sub-modules, a proximity-based detection module and a proximity-based transmission module, or as one unified module. (The example of NFC is only one example, and is not intended to limit the applicability of the configurations provided for herein to other proximity-based technologies.)

Additionally, the interactive computing device 101 may have a sensor 303 that is used by the processor 301 to determine various environmental data. For instance, the sensor 303 may be a location-based sensor that determines the location of the interactive computing device 101, and thereby potentially determining the applicable context. As another example, the sensor 303 may be thermometer that determine the temperature of the surrounding environment (e.g., a colder temperature may indicate the user being outside the building whereas a warmer temperature may indicate the user being inside the building at the cafeteria). As yet another example, the sensor 303 may be a decibel meter that measures ambient noise (e.g., a greater level of noise may indicate the user being outside the building whereas a lesser amount of noise may indicate the user being at his or her desk by a PC). The sensor 303 may be utilized to measure other forms of data. Furthermore, the processor 301 may use a combination of data measurements to more reliably determine a context (e.g., location, temperature, and decibel reading).

Moreover, the interactive computing device 101 may have one or more input/output (“I/O”) devices 306 that may receive inputs and provide outputs. Various devices (e.g., keyboard, microphone, mouse, pointing device, hand controller, joystick, etc.) may be used for the I/O devices 306. The system configuration may also have a transceiver 305 to send and receive data. Alternatively, a separate transmitter and receiver may be used instead.

By way of contrast, FIG. 3B illustrates a system configuration for the server 201 illustrated in FIG. 2B. The server 201 has a processor 351, which may be specialized in determining a particular context for the interactive computing device 101. For example, a data storage device 355 may store location analysis code 356, which may be temporarily stored by a memory device 352, for execution by the processor 351 to determine a context based on location data sensed by the interactive computing device 101 as compared with the location database 251, illustrated in FIG. 2B. As another example, the data storage device 355 may store automated context selection code 357, which may be temporarily stored by a memory device 352, for execution by the processor 351 to generate automated selection of a context, without the need for the user 102 to provide an input selecting the context.

Moreover, the server 201 may have one or more I/O devices 354 that may receive inputs and provide outputs. Various devices (e.g., keyboard, microphone, mouse, pointing device, hand controller, joystick, etc.) may be used for the I/O devices 354. The system configuration may also have a transceiver 353 to send and receive data. Alternatively, a separate transmitter and receiver may be used instead.

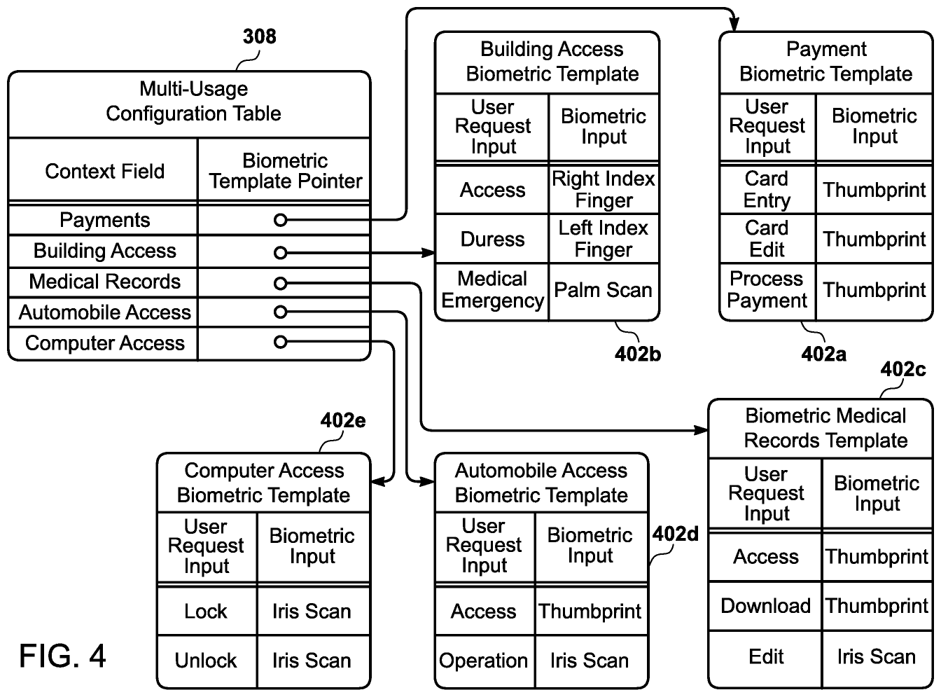

FIG. 4 illustrates an example of the multi-usage configuration table 308 stored by the data storage device 307 of the interactive computing device 101 illustrated in FIG. 3A. For instance, the multi-usage configuration table 308 may have various context fields that correspond to the context indicia 104a-e to be displayed within the GUI 103, such as a payments, building access, medical records, automobile access, and computer access. (The foregoing contexts are provided only as examples, given that many other types of context fields may be utilized within the multi-usage configuration table 308.) Furthermore, as indicated in the multi-usage configuration table 308, each context field may have a corresponding biometric template pointer. (For illustrative purposes, visual pointers are illustrated; however, for programmatic purposes, memory addresses or other identifiers may be used in place of the visual pointers.)

As an example, the payments context field may correspond to a payments biometric template 402a, indicated by the biometric template pointer corresponding to the payments context field. For instance, the payments biometric template 402a may have various user request inputs, such as “card entry,” “card edit,” and “process payment,” with the same or varying biometric input requirements; in this case, a thumbprint for each of the user request inputs.

As another example, the building access context field may correspond to a building access biometric template 402b, indicated by the biometric template pointer corresponding to the building access context field. For instance, the building access template 402b may have various user request inputs, such as “access,” “duress,” and “medical emergency,” with different biometric input requirements for each user request input; in this case, a right index finger input for “access,” a left index finger for “duress,” and a palm scan for “medical emergency.” In other words, in one embodiment, the user may have knowledge, or have that information displayed by the GUI 103 of the interactive computing device 101, of what biometric inputs correspond to what user request inputs, and may provide a biometric input to indicate the type of user request, rather than having to submit a user request first to the interactive computing device 101 and then submit the corresponding biometric input. This embodiment is particularly implemented in a practical manner when the biometric inputs for a given biometric template are each unique (e.g., right index finger corresponding to one type of user request as opposed to left index finger corresponding to another type of user request).

As yet another example, the medical records context field may correspond to a medical records biometric template 402c, indicated by the biometric template pointer corresponding to the medical records context field. For instance, the medical records biometric template 402c may have various user request inputs, such as “access,” “download,” and “edit,” with the same or varying biometric input requirements; in this case, a thumbprint is required for “access” and “download,” but an iris scan, presumably a higher security threshold to meet, is required for “edit.”

In another example, the automobile context field may correspond to an automobile biometric template 402d, indicated by the biometric template pointer corresponding to the automobile context field. For instance, the automobile biometric template 402d may have various user request inputs, such as “access” and “operation,” with the same or varying biometric input requirements; in this case, a thumbprint is required for “access,” but an iris scan, presumably a higher security threshold to meet, is required for “operation.”

As a final example, the computer access context field may correspond to a computer access biometric template 402e, indicated by the biometric template pointer corresponding to the computer access context field. For instance, the computer access biometric template 402e may have various user request inputs, such as “lock” and “unlock,” with the same or varying biometric input requirements; in this case, an iris scan is required for both “lock” and “unlock” to securely protect the data stored on the user's computer.

The foregoing illustrations are intended to emphasize the versatility and applicability of the multi-usage configuration table 308. Various other types of contexts may be implemented in conjunction with the multi-usage configuration table 308. Furthermore, additional or different fields may be implemented within the multi-usage configuration table 308. For instance, different encryption requirements may be necessitated for different contexts, and possibly for different biometric modalities within a given biometric template. Also, different transmission requirements (e.g., frequencies) may be necessitated for different contexts, and possibly for different biometric modalities within a given biometric template. Additionally, the multi-usage configuration table 308 may further specify different configuration parameters for different entities (e.g., buildings, hardware, etc.) grouped into the same context. For example, not every building may necessitate a right index finger for access; some, for instance, may require an iris scan, a different finger on a different hand, etc. instead. Accordingly, the multi-usage configuration table 308 may have further rows and/or fields that indicate sub-context parameters for specific entities, such as entities located at particular GPS coordinates based on geolocation data received from the interactive computing device 101.

The multi-usage configuration table 308 allows for improved memory management of the interactive computing device 101. Rather than having to store all of the biometric data in one data structure, the multi-usage configuration table 308 may store pointers (e.g., memory addresses) to the biometric pointer templates 402a-e, effectively minimizing the amount of data storage. As a result, the multi-usage configuration table 308 not only allows for universal biometric validation from a single interactive computing device 101, but also optimizes the efficiency with which data may be retrieved (i.e., faster biometric modality retrieval for biometric validation request).

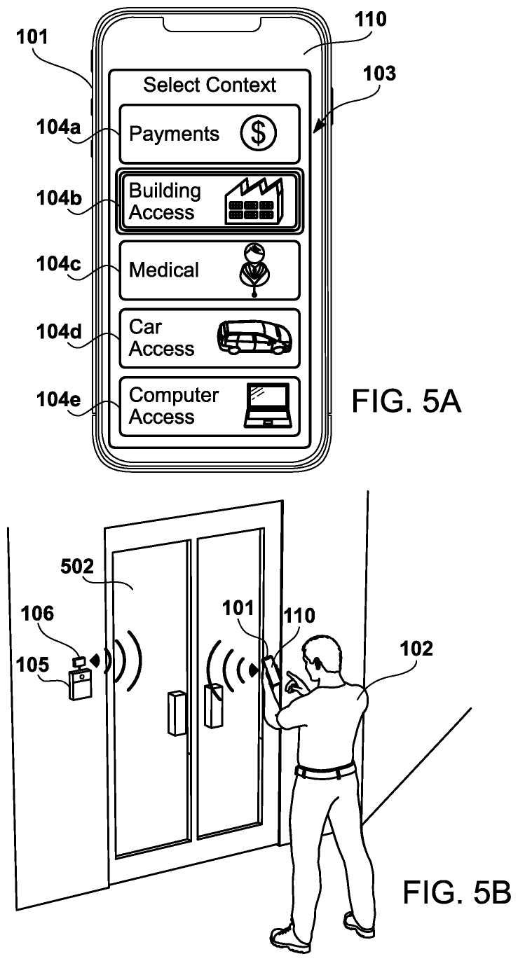

FIGS. 5A and 5B illustrate examples of the interactive computing device 101 being utilized to obtain access to an access-controlled building. As illustrated in FIG. 5A, the GUI 103 depicts the building access indicium 104b as the selected context. For example, the user 102, illustrated in FIG. 1A, may have provided a user input (e.g., touch-screen input on the display 104, gesture command, voice input, etc.). As another example, the server 201 may have automatically performed the context selection of the building access indicium 104b for the user 102, such as with geolocation data received from the sensor 303 illustrated in FIG. 3A. The automatic selection performed by the server 201 may be displayed via the GUI 103. Alternatively, the server 201 may perform the automatic selection, which may not necessarily have to be displayed on the display screen 105.

Moreover, FIG. 5B illustrates the user 102 providing an input via the biometric modality specified by the multi-usage configuration table 308 illustrated in FIG. 4 to obtain access to a building in a controlled access building context. For example, the building access biometric template 402b pointed to by the biometric template pointer corresponding to the building access context field of the multi-usage configuration table 308 indicates that a right index finger input is the biometric modality for accessing a building. Optionally, the user 102 may receive an indication (visual, audio, etc.) from the interactive computing device 101 requesting that the user place his or her right index finger on the interactive computing device 101 to provide the input for that specific biometric modality. Subsequently, the interactive computing device 101 may perform the biometric validation, without the assistance of the server 201. If the biometric input (e.g., right index fingerprint) provided by the user 102 matches the corresponding biometric input stored locally by the interactive computing device 101 within the biometric validation database 310 of the data storage device 307, the interactive computing device 101 activates the proximity-based module (e.g., NFC physical circuit or NFC logical circuit) to transmit the building access credentials of the user 102 to the proximity-based reader 105 (e.g., NFC reader). Subsequently, the proximity-based reader 105 may transmit the credentials of the user 102, without the biometric data, to an access controller that may activate the door 502 to provide access to the user 102. In other words, the biometric validation performed internally by the interactive computing device 101 is performed to allow the release of the user credentials to the proximity-based reader 105, not for the biometric data to be sent to the proximity-based reader 105.

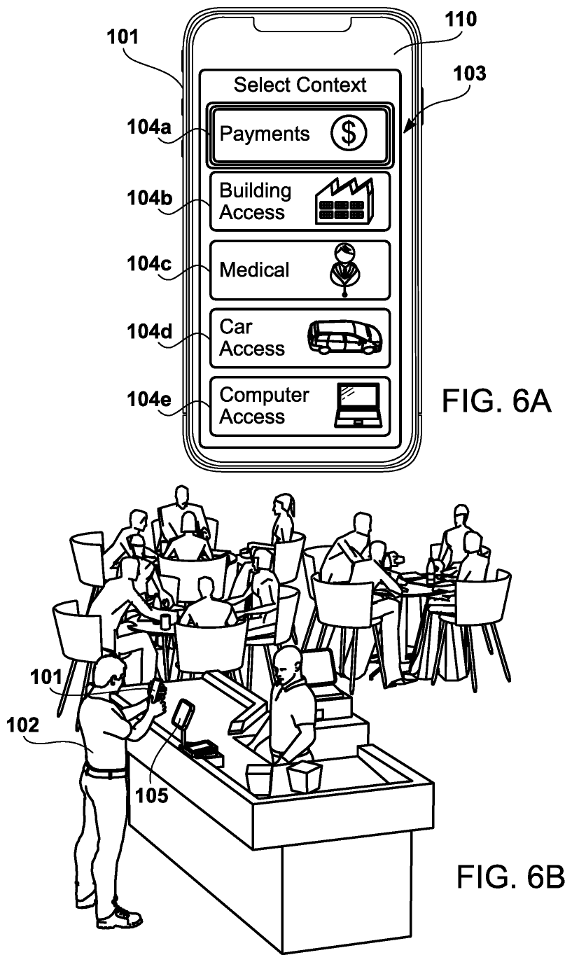

FIGS. 6A and 6B illustrate examples of the interactive computing device 101 being utilized to process a payment in a cafeteria of the access-controlled building illustrated in FIG. 5B. (The payment is only illustrated as being processed in a cafeteria of the access-controlled building to provide a realistic example. Payments may be applied in other areas (e.g., parking kiosk, vending machine, etc.) of the access-controlled building or in a building or area that is not even access-controlled.)

As illustrated in FIG. 6A, the GUI 103 depicts the payments indicium 104a as the selected context. A user input or an automatic selection may have been performed to effectuate the selection of the payments indicium 104a.

Moreover, FIG. 6B illustrates the user 102 providing an input via the biometric modality specified by the multi-usage configuration table 308 illustrated in FIG. 4 to provide payment in a payment context. For example, the payment template 402a pointed to by the biometric template pointer corresponding to the payment context field of the multi-usage configuration table 308 indicates that a thumbprint input is the biometric modality for payments. Optionally, the user 102 may receive an indication (visual, audio, etc.) from the interactive computing device 101 requesting that the user place his or her thumb on the interactive computing device 101 to provide the input for that specific biometric modality. Subsequently, the interactive computing device 101 may perform the biometric validation, without the assistance of the server 201. If the biometric input (e.g., thumbprint) provided by the user 102 matches the corresponding biometric input stored locally by the interactive computing device 101 within the biometric validation database 310 of the data storage device 307, the interactive computing device 101 activates the proximity-based module (e.g., NFC physical circuit or NFC logical circuit) to transmit the payment information (e.g., credit card information) of the user 102 to the proximity-based reader 105 (e.g., NFC reader). In this instance, the proximity-based reader 105 may be a payment terminal at a merchant POS within the cafeteria of the illustrated example. Subsequently, the proximity-based reader 105 may transmit the payment information of the user 102, without the biometric data, to a financial institution associated with the credit card information to process payment for the meal of the user at the cafeteria. Upon approval by the payment terminal of the credit card information of the user, the meal purchase transaction is completed.

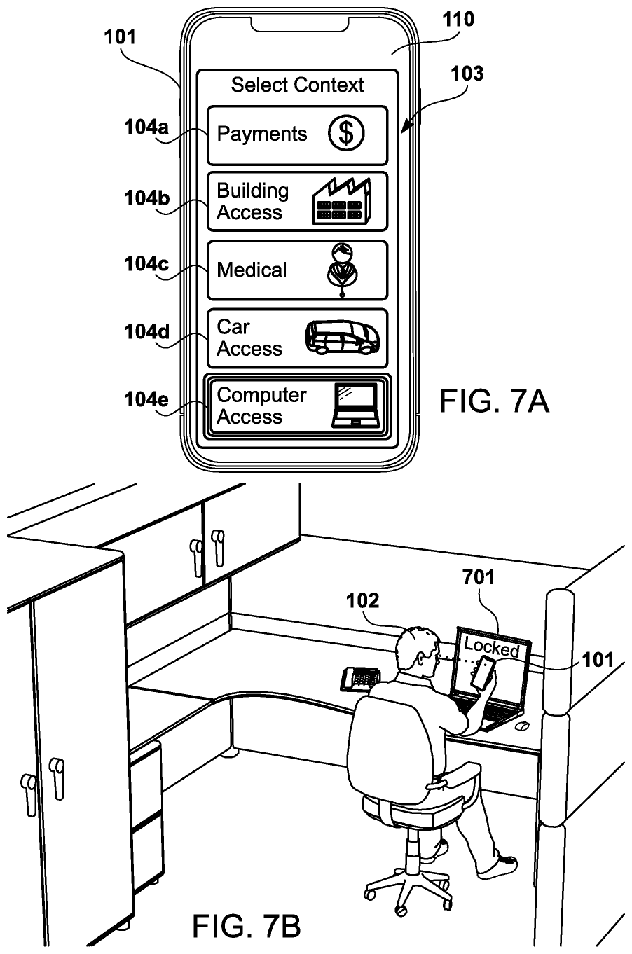

FIGS. 7A and 7B illustrate examples of the interactive computing device 101 being utilized to obtain access to a laptop 701 located within the controlled-access building. For example, the user 102 may work in the controlled-access building. (A laptop is only one example; other examples may include, but are not limited to, PCs, 3D printers, scanners, photocopiers, fax machines, machinery, laboratory equipment, safe, or other computing devices.) As illustrated in FIG. 7A, the GUI 103 depicts the computer access indicium 104e as the selected context. A user input or an automatic selection may have been performed to effectuate the selection of the payments indicium 104e.

Moreover, FIG. 7B illustrates the user 102 providing an input via the biometric modality specified by the multi-usage configuration table 308 illustrated in FIG. 4 to unlock access to the laptop 701. For example, the computer access template 402e pointed to by the biometric template pointer corresponding to the computer access context field of the multi-usage configuration table 308 indicates that an iris scan input is the biometric modality for computer access. Optionally, the user 102 may receive an indication (visual, audio, etc.) from the interactive computing device 101 requesting that the user place his or her eye in proximity to the interactive computing device 101 to provide the input for that specific biometric modality. Subsequently, the interactive computing device 101 may perform the biometric validation, without the assistance of the server 201. If the biometric input (e.g., iris scan) provided by the user 102 matches the corresponding biometric input stored locally by the interactive computing device 101 within the biometric validation database 310 of the data storage device 307, the interactive computing device 101 activates the proximity-based module (e.g., NFC physical circuit or NFC logical circuit) to transmit the user's login credentials (e.g., username and password) to the proximity-based reader 105 (e.g., NFC reader). In this instance, the proximity-based reader 105 may be an NFC reader that is in operable communication (e.g., wireless transmission (Wi-Fi, BLUETOOTH, etc.), wired (ETHERNET, cable, etc.), or accessory device transmission (e.g., USB device, disk, etc.) with the laptop 701. Upon authentication of login credentials of the user 102, the laptop 701 grants access to the user 102.

The examples provided in FIGS. 5A-7B are intended only as examples. Accordingly, the multi-usage configuration table 308 may be used for a wide variety of contexts, thereby allowing the interactive computing device 101 to be a single, portable biometric validation device for proximity-based transmissions to send data to a the proximity-based reader 105 to obtain access or processing of a service, and potentially to receive data back (e.g., a download of medical records to the interactive computing device 101) from a proximity-based transmitter 106. Accordingly, the proximity-based module 304 illustrated in FIG. 3A may have integrated proximity-based detection, proximity-based transmission, and proximity-based reception functionalities, or may be decomposed into one or more sub-modules (some or all of which may be physical or logical circuits) for performing such functionalities.

Furthermore, although the configurations illustrated in FIGS. 5A-7B depict contactless communication, the interactive computing device 101 may be utilized to generate/receive a one-time password that is then utilized by the user 102 to obtain access to a service. For instance, upon performing biometric validation of the user 102, the interactive computing device 101 may display a one-time password, which the user 102 may then use to enter at a building access panel, PC, etc. to obtain access.

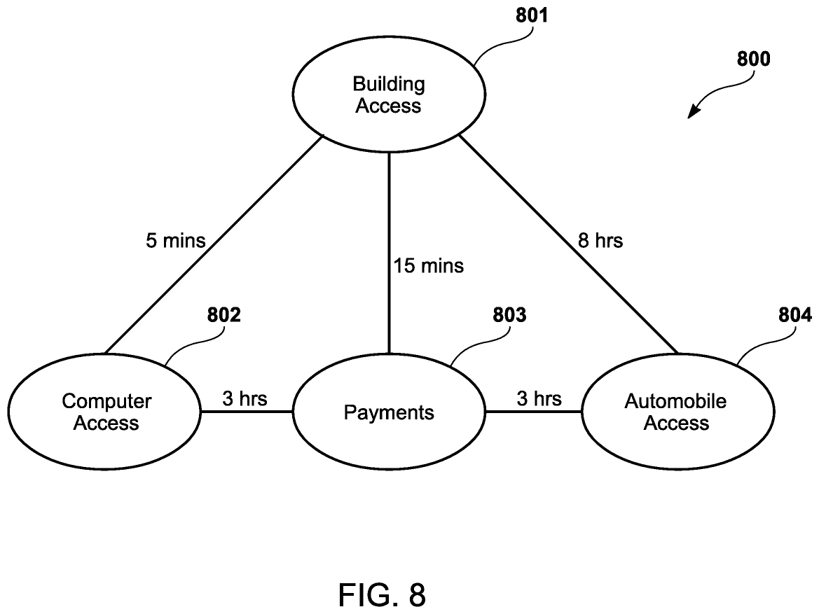

In addition, the server 201 may generate a time-based context selection data structure 800, as illustrated in FIG. 8, to automatically select a context for the user 102. For example, the time-based context selection data structure 800 may be a multi-node graph having a plurality of nodes, each of which represent a context. For example, the multi-node graph may have a building access node 801, a computer access node 802, a payments node 803, and an automobile access node 804. Furthermore, the edges between the individual nodes may indicate the average time that the user 102 has previously spent before moving from one node to another. For example, the user 102 may typically spend five minutes walking to his or her computer after accessing the controlled-access building, but may take eight hours before accessing his or her automobile again after such building access. Accordingly, the server 201 may determine, based on statistical occurrences, the probability of a user attempting to access a particular context, even within the same general geographical location, without the user providing a context input. For instance, the server 201 may determine that the user is unlikely to be attempting to unlock his or her laptop 701 or provide a payment at the cafeteria of the building when the user has not yet even accessed the building. Therefore, the server 201 may determine that the first context when the user arrives at the location of the building is a building access context, and may automatically present the building access context to the user 102. Subsequently, the server 201 may utilize the time-based context selection data structure 800 to follow a statistically typical sequence of events of the user throughout his or her day to provide additional automatic context selections. In one embodiment, the server 201 may utilize the AI 252 to perform such analysis and/or provide recommendations to the user for context selection. The interactive computing device 101 may provide the user 102 with the ability to override the automatic context selection, or recommendation, via an override command (e.g., visual override indicium, voice command, etc.); such override may invoke rendering of the GUI 103 for the user to provide an input of a correct context selection.

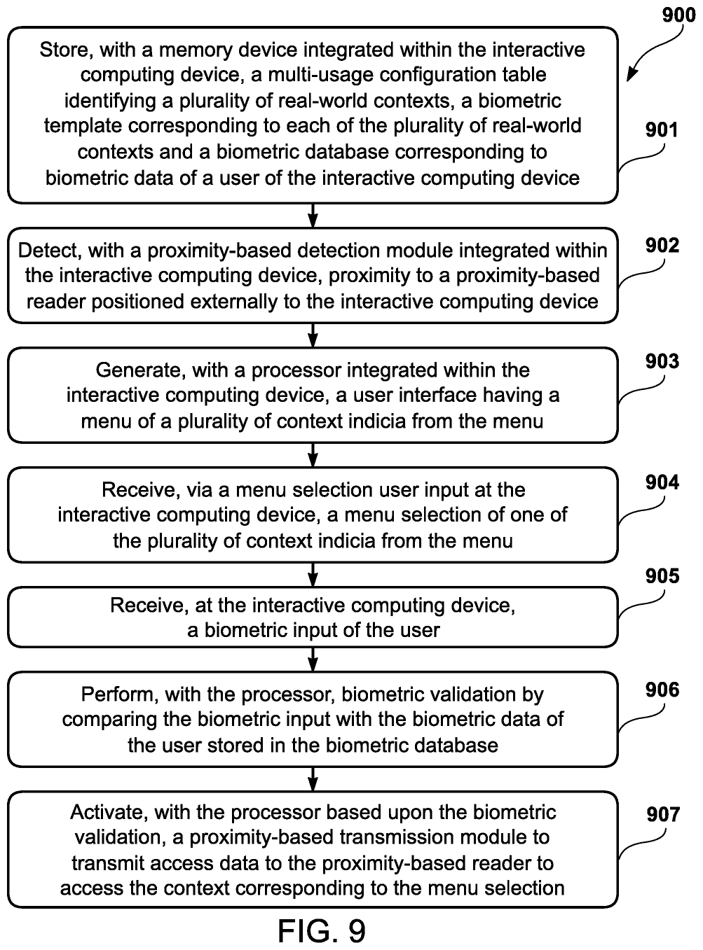

FIG. 9 illustrates a process 900 that may be utilized by the interactive computing device 101 to transmit data from the proximity-based module 304, illustrated in FIG. 3A, to a proximity-based reader 105 based upon a user menu selection from contexts corresponding to the multi-usage configuration table 308, illustrated in FIG. 4. At a process block 901, the process 900 stores, with the memory device 302 integrated within the interactive computing device 101, the multi-usage configuration table 308 identifying a plurality of real-world contexts, a biometric template 309 corresponding to each of the plurality of real-world contexts, and a biometric database 310 corresponding to biometric data of a user of the interactive computing device 101. The biometric template 309 identifies one or more biometric modalities based on one or more access request types. The plurality of real-world contexts are distinct from one another.

Additionally, at a process block 902, the process 900 detects, with a proximity-based detection module 304 integrated within the interactive computing device 101, proximity to a proximity-based reader 105 positioned externally to the interactive computing device 101. In one embodiment, the proximity-based detection module 304 is integrated into the proximity-based module 304; in another embodiment, it is a distinct module from the proximity-based module 304. Furthermore, at a process block 903, the process 900 generates, with a processor 301 integrated within the interactive computing device 101, a user interface 103 having a menu of a plurality of context indicia. Each of the plurality of context indicia corresponds to one of the plurality of real-world contexts. At a process block 904, the process 900 receives, via a menu selection user input at the interactive computing device 101, a menu selection of one of the plurality of context indicia from the menu. Also, at a process block 905, the process 900 receives, at the interactive computing device 101, a biometric input of the user 102. At a process block 906, the process 900 performs, with the processor 301, biometric validation by comparing the biometric input with the biometric data of the user 102 stored in the biometric database 310. Finally, at a process block 907, the process 900 activates, with the processor 301 based upon the biometric validation, a proximity-based transmission module 304 to transmit access data to the proximity-based reader 105 to access the context corresponding to the menu selection. In one embodiment, the proximity-based transmission module is integrated into the proximity-based module 304; in another embodiment, it is a distinct module from the proximity-based module 304.

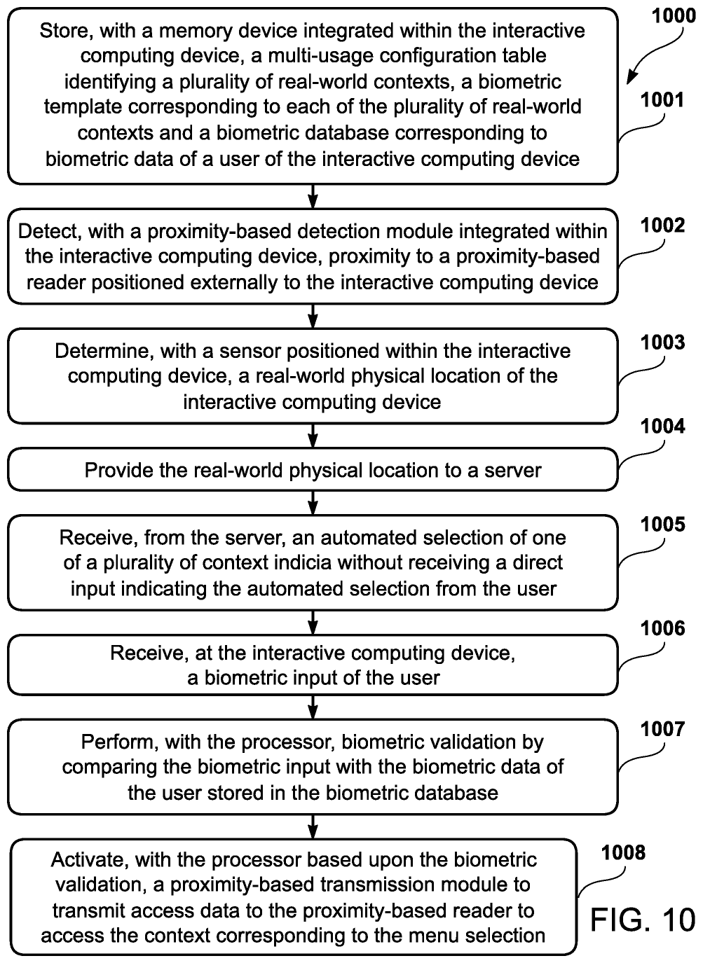

By way of contrast, FIG. 10 illustrates a process 1000 that may be utilized by the interactive computing device 101 to transmit data from the proximity-based module 304, illustrated in FIG. 3A, to a proximity-based reader 105 based upon an automated selection from contexts corresponding to the multi-usage configuration table 308, illustrated in FIG. 4. At a process block 1001, the process 1000 stores, with the memory device 302 integrated within the interactive computing device 101, the multi-usage configuration table 308 identifying a plurality of real-world contexts, a biometric template 309 corresponding to each of the plurality of real-world contexts, and a biometric database 310 corresponding to biometric data of a user of the interactive computing device. Furthermore, at a process block 1002, the process 1000 detects, with a proximity-based detection module integrated within the interactive computing device 101, proximity to a proximity-based reader 105 positioned externally to the interactive computing device 101.

At a process block 1003, the process 1000 determines, with a sensor 303 positioned within the interactive computing device 101, a real-world physical location of the interactive computing device 101. Furthermore, at a process block 1004, the process 1000 provides the real-world physical location to the server 201, illustrated in FIGS. 2A and 2B. At a process block 1005, the process 1000 receives, from the server 201, an automated selection of one of a plurality of context indicia without receiving a direct input indicating the automated selection from the user 102. The one of the plurality of context indicia corresponds to the real-world physical location.

Additionally, at a process block 1006, the process 1000 receives, at the interactive computing device 101, a biometric input of the user 102. At a process block 1007, the process 1000 performs, with the processor 301, biometric validation by comparing the biometric input with the biometric data of the user 102 stored in the biometric database 310. Finally, at a process block 1008, the process 1000 activates, with the processor 301 based upon the biometric validation, a proximity-based transmission module to transmit access data to the proximity-based reader 105 to access the context corresponding to the menu selection.

It is understood that the processes, systems, apparatuses, and computer program products described herein may also be applied in other types of processes, systems, apparatuses, and computer program products. Those skilled in the art will appreciate that the various adaptations and modifications of the embodiments of the processes, systems, apparatuses, and computer program products described herein may be configured without departing from the scope and spirit of the present processes and systems. Therefore, it is to be understood that, within the scope of the appended claims, the present processes, systems, apparatuses, and computer program products may be practiced other than as specifically described herein.

I claim:

1. A computer program product comprising a non-transitory computer useable storage device having a computer readable program, wherein the computer readable program when executed on an interactive computing device causes the interactive computing device to:
store, with a memory device integrated within the interactive computing device, a multi-usage configuration table identifying a plurality of real-world contexts, a biometric template corresponding to each of the plurality of real-world contexts, and a biometric database corresponding to biometric data of a user of the interactive computing device, the biometric template identifying one or more biometric modalities based on one or more access request types, the plurality of real-world contexts being distinct from one another;
detect, with a proximity-based detection module integrated within the interactive computing device, proximity to a proximity-based reader positioned externally to the interactive computing device;
generate, with a processor integrated within the interactive computing device, a user interface having a menu of a plurality of context indicia, each of the plurality of context indicia corresponding to one of the plurality of real-world contexts;
receive, via a menu selection user input at the interactive computing device, a menu selection of one of the plurality of context indicia from the menu;
receive, at the interactive computing device, a biometric input of the user;
perform, with the processor, biometric validation by comparing the biometric input with the biometric data of the user stored in the biometric database; and
activate, with the processor based upon the biometric validation, a proximity-based transmission module to transmit access data to the proximity-based reader to access the context corresponding to the menu selection.

2. The computer program product of claim 1, wherein the interactive computing device is further caused to determine, with the processor, an access request based on the biometric input provided by the user without the user providing a direct input corresponding to the access request.

3. The computer program product of claim 1, wherein the interactive computing device is further caused to determine, with the processor, an access request based on an input provided by the user prior to providing the biometric input.

4. The computer program product of claim 1, wherein the interactive computing device is further caused to determine, with the processor, an access request based on an input provided by the user subsequent to providing the biometric input.

5. The computer program product of claim 1, wherein the proximity-based transmission module is an NFC physical circuit.

6. The computer program product of claim 1, wherein the proximity-based transmission module is an NFC logical circuit.

7. The computer program product of claim 1, wherein the interactive computing device is further caused to activate, with the processor based upon the biometric validation, a proximity-based reception module to receive data from a proximity-based transmitter in operable communication with the proximity-based reader.

8. The computer program product of claim 1, wherein the interactive computing device is further caused to provide a visual cue of a biometric input type so that the user is aware of the biometric input to provide to the interactive computing device.

9. A computer program product comprising a non-transitory computer useable storage device having a computer readable program, wherein the computer readable program when executed on an interactive computing device causes the interactive computing device to:
store, with a memory device integrated within the interactive computing device, a multi-usage configuration table that identifies a plurality of real-world contexts, a biometric template corresponding to each of the plurality of real-world contexts, and a biometric database corresponding to biometric data of a user of the interactive computing device, the biometric template identifying one or more biometric modalities based on one or more access request types, the plurality of real-world contexts being distinct from one another;
detect, with a proximity-based detection module integrated within the interactive computing device, proximity to a proximity-based reader positioned externally to the interactive computing device;
determine, with a sensor positioned within the interactive computing device, a real-world physical location of the interactive computing device;
provide the real-world physical location to a server;
receive, from the server, an automated selection of one of a plurality of context indicia without receiving a direct input indicating the automated selection from the user, said one of the plurality of context indicia corresponding to the real-world physical location;
receive, at the interactive computing device, a biometric input of the user;
perform, with the processor, biometric validation by comparing the biometric input with the biometric data of the user stored in the biometric database; and
activate, with the processor based upon the biometric validation, a proximity-based transmission module to transmit access data to the proximity-based reader to access to the context corresponding to the automated selection.

10. The computer program product of claim 9, wherein the automated selection is based on a correspondence between the real-world physical location and one of the one or more biometric modalities.

11. The computer program product of claim 10, wherein the automated selection is further based on a time-based probabilistic correspondence between the real-world physical location and said one of the one or more biometric modalities.

12. The computer program product of claim 9, wherein the interactive computing device is further caused to receive a user override input, invoke an override instruction based on the user override input, and generate a user interface having a menu of a plurality of context indicia, each of the plurality of context indicia corresponding to one of the plurality of real-world contexts.

13. The computer program product of claim 9, wherein the proximity-based transmission module is an NFC physical circuit.

14. The computer program product of claim 9, wherein the proximity-based transmission module is an NFC logical circuit.

15. The computer program product of claim 9, wherein the interactive computing device is further caused to activate, with the processor based upon the biometric validation, a proximity-based reception module to receive data from a proximity-based transmitter in operable communication with the proximity-based reader.

16. An interactive computing device comprising:
a memory device integrated within the interactive computing device, the memory device storing a multi-usage configuration table that identifies a plurality of real-world contexts, a biometric template corresponding to each of the plurality of real-world contexts, and a biometric database corresponding to biometric data of a user of the interactive computing device, the biometric template identifying one or more biometric modalities based on one or more access request types, the plurality of real-world contexts being distinct from one another;
a proximity-based detection module integrated within the interactive computing device, the proximity-based detection module detecting proximity to a proximity-based reader positioned externally to the interactive computing device;
a proximity-based transmission module;
a user input device integrated within the interactive computing device, the user input device receiving a biometric input of the user; and
a processor that determines one of a plurality of context indicia, performs biometric validation by comparing the biometric input with the biometric data of the user stored in the biometric database, and activates, based upon the biometric validation, the a proximity-based transmission module to transmit access data to the proximity-based reader to access to the context corresponding to the automated selection.

17. The interactive computing device of claim 16, further comprising a display device that renders a user interface having a menu of a plurality of context indicia, the user input device receiving a menu selection from the user, the processor performing the determination of said one of the plurality of context indicia based on the menu selection.

18. The interactive computing device of claim 16, further comprising a receiver that receives, from the server, an automated selection of said one of a plurality of context indicia without receiving a direct input indicating the automated selection from the user.

19. The interactive computing device of claim 16, wherein the proximity-based transmission module is an NFC physical circuit.

20. The interactive computing device of claim 16, wherein the proximity-based transmission module is an NFC logical circuit.
